(19) United States
(12) Patent Application Publication
(10) Pub. No.: US 2006/0136606 A1
(43) Pub. Date: Jun. 22, 2006

(54) Logic device comprising reconfigurable core logic for use in conjunction with microprocessor-based computer systems

(76) Inventors: D. James Guzy, Glenbrook, NV (US); Lee Burton, Divide, CO (US); Jon M. Huppenthal, Colorado Springs, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/992,871

(22) Filed: Nov. 19, 2004

(51) Int. Cl. G06F 3/00

(52) U.S. Cl. 710/1

(57) ABSTRACT

A logic device comprising reconfigurable core logic for use in conjunction with microprocessor-based computer systems which may be implemented as fully reconfigurable circuitry or a combination of reconfigurable logic and fixed logic sections. The core logic may contain parameterized functions that are selectable dynamically or during a manufacturing process and can allow for the dynamic, or predetermined, reallocation of external bandwidth between two or more ports. The fully reconfigurable circuitry, or a combination of reconfigurable and fixed logic, may be co-fabricated on a single die or formed by integrated circuit die stacking techniques. At least portions of the reconfigurable logic circuitry may be configured to function as one or more direct execution logic (DEL) reconfigurable processing elements that may function as effective peers with the associated microprocessor(s) in terms of accessing computing system resources.

### CROSS REFERENCE TO RELATED PATENT APPLICATIONS

The present invention is related to the subject matter of U.S. Pat. Nos. 6,627,985 issuing on Sep. 30, 2003 and 6,781,226 issuing on Aug. 24, 2004 for: “Reconfigurable Processor Module Comprising Hybrid Stacked Integrated Circuit Die Elements”, both assigned to Arbor Company, assignee of the present invention. The present invention is related to the subject matter of U.S. patent application Ser. No. 10/802,067 filed Mar. 16, 2004 for: “Reconfigurable Processor Module Comprising Hybrid Stacked Integrated Circuit Die Elements”, also assigned to Arbor Company. The disclosures of the foregoing patents and patent application are specifically incorporated herein by this reference in their entirety.

### BACKGROUND OF THE INVENTION

The present invention relates, in general, to the field of microprocessor-based computer systems. More particularly, the present invention relates to a logic device comprising reconfigurable core logic for use in conjunction with microprocessor-based computer systems.

Currently, computer systems utilizing dense logic devices such as microprocessors typically require the conjunctive use of some form of chipset commonly referred to as “core logic”. The purpose of this core logic is to perform functions that are needed by a computer system, but are not necessarily provided by the microprocessor itself. Examples of these functions are display, peripheral input/output (I/O) access and main memory access. Obviously, the performance levels required across these three functions alone will vary greatly depending on the particular application. Because of this, a variety of chipsets exist for almost every microprocessor, providing a variety of performance mixes and price points. Moreover, since any given microprocessor will have finite functionality and finite external bandwidth, it is then the function of the core logic to provide all remaining desired functions via the available microprocessor interconnect bandwidth through the front side bus (FSB).

### SUMMARY OF THE INVENTION

Unlike all currently available, standard core logic that exhibit fixed functionality, if core logic were developed that contained reconfigurable logic, its functionality could then be varied on a need-by-need basis while eliminating the high development costs associated with making a number of different, application specific chipsets. Such core logic could, for example, divide up the fixed available bandwidth differently by reassigning pins and gates to support a display intensive application as opposed to a memory intensive application. It may also implement yet a different mix for an I/O intensive application.

For example, if one were to choose to use PCI Express X8 instead of PCI Express X4 it is possible to obtain substantially double the bandwidth by allocating twice as many pins to a particular I/O function. Yet another example would be to again reassign pins to implement a double channel memory controller as opposed to a single channel controller for applications requiring maximum memory bandwidth. It would also be possible to implement custom interfaces such as SRC Computers SNAP™, or as yet unknown I/O standards, without designing and manufacturing a new chip.

Reconfigurations of these parts can be effectuated in either a fixed fashion at the time the mother board is assembled or on a dynamic application-by-application basis. First, the user or motherboard manufacturer would decide what mix of interfaces was desired. Conveniently, all of the available interfaces may be reduced to a library of circuit “macros” prior to this step. The second step is then to select the appropriate macros from the library. Thirdly, a place and route program may be run to actually generate the circuitry that would incorporate the desired macro set. The output from this process would be a binary configuration file. Fourthly, this file would be loaded either directly into the reconfigurable core logic or into an adjacent configuration programmable read only memory (PROM). The reconfigurable core logic can then be activated causing it to load the configuration file and be ready for use.

In addition to this port reconfiguration capability, it is also possible to implement a variety of functions in the core logic. For example, suppose a non-linear memory data access pattern is desired. In a standard system today, full cache lines must be retrieved from memory for each element that is desired. This can easily mean that, for example, 16 times more data must be read by the processor than is actually needed. Today's core logic is forced to do this because its functionality must be determined at the time of design. In turn, this forces a design methodology that is usable for all applications, thus preventing it from being optimized for a particular application.

On the other hand, and in accordance with the disclosure of the present invention, if a parameterized data pre-fetch functional unit were instantiated in the core logic, parameters transferred to it from the processor could cause it to change its circuit functionality and access memory in a nonlinear, application-specific fashion and then extract and compact only the data desired by the processor. This would then result in as much as a 16x improvement in bandwidth efficiency for this example, and could be done based off the data read command that it receives from the processor. This could be accomplished if all, or at least a portion, of the core logic were reconfigurable.

While it is also possible to accomplish at least a portion of this operational functionality choice with non-reconfigurable logic, the circuitry must nevertheless be determined in advance and set at the time the chip is designed. In addition, much more logic will be consumed since all desired options must be implemented in gates at the time of manufacture as opposed to simply providing a single set of gates that can be reconfigured. The complement of data pre-fetch and data access functional units can be quite diverse depending on the target applications and can even include math functions. Again, the provision and use of a reconfigurable core logic chip set in accordance with the present invention allows this complement to either be set at the time of board build, or reconfigured on an application by application basis.

This desired functionality may be accomplished in at least two ways. Either the device can be 100% reconfigurable, or it can combine some amount of fixed logic, such as the front side bus interface, with some amount of reconfigurable logic such as for data pre-fetch or I/O port selection. Further, the actual physical implementation of such core logic can be accomplished in several ways. First, by combining known techniques for fabrication of static random access memory (SRAM) based reconfigurable logic with compatible fabrication techniques for standard logic, it is possible to fabricate both logic types on a single die. This is very similar to the fabrication process used today to create high-end microprocessors with SRAM caches on the same die. The drawback to this is that it requires fairly sophisticated wafer processing and results in a very large die area. This, in turn, is more prone to wafer defects that will reduce yield unless very tight process controls are maintained.

Yet another technique is to stack a standard reconfigurable device on top of a standard logic device as disclosed and claimed, for example, in the foregoing issued patents and pending patent application. This has the distinct advantage of using two smaller die which will inherently have higher yields than the single large die while requiring only the additional die stacking operation. A third alternative is to use a 100% reconfigurable device to accomplish all of the core logic functions.

Previously, SRC Computers, Inc., Colorado Springs, Colo. has used standard field programmable gate arrays (FPGAs) to provide an application specific integrated circuit (ASIC) replacement bridge chip that was able to connect directly to the Intel® P6 FSB, thus showing the viability of using reconfigurable devices to connect to the FSB. However, unlike the present invention, this technique essentially provided a fixed design with little capability to be reconfigured once in the system and could not effectively alter its I/O complement as disclosed herein nor perform all of the typical Northbridge functions other than a connection to the FSB. Effectively the design was primarily intended as a replacement for what would have been an ASIC for use in addition to the standard Northbridge, and not as a replacement for it.

In accordance with the technique of the present invention, it is also possible to partition the core logic functions across multiple components, some or all of which may be reconfigurable, much like today's chipsets are partitioned between “North Bridges” and “South Bridges”.

Particularly disclosed herein is a logic device comprising reconfigurable core logic for use in conjunction with microprocessor-based computer systems which may be implemented as fully reconfigurable circuitry or a combination of reconfigurable logic and fixed logic sections. The core logic may contain parameterized functions that are selectable dynamically or during a manufacturing process and can allow for the dynamic, or predetermined, reallocation of external bandwidth between two or more ports. The fully reconfigurable circuitry, or combination of reconfigurable and fixed logic, may be co-fabricated on a single die or formed by integrated circuit die stacking techniques.

Also particularly disclosed herein is a logic device for coupling at least one microprocessor to a memory system comprising a reconfigurable logic section for interfacing said logic device to said memory system. In alternative embodiments disclosed herein, the logic device may further comprise a fixed logic section for interfacing said logic device to said at least one microprocessor.

At least portions of the reconfigurable logic section may also additionally be configured to function as one or more direct execution logic (DEL) reconfigurable processing elements that may function as effective peers with the associated microprocessor(s) in terms of accessing computing system resources.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a functional block diagram of a portion of a computer system implemented in conjunction with a conventional core logic chipset and non-interleaved memory;

FIG. 2 is a corresponding functional block diagram of a portion of a computer system implemented in conjunction with a conventional core logic chipset with interleaved memory and an I/O-based graphics port;

FIG. 3 is a functional block diagram of a portion of a computer system implemented in conjunction with an at least partially reconfigurable core logic chipset in accordance with the present invention and utilizing non-interleaved memory;

FIG. 4 is a corresponding functional block diagram of a portion of a computer system implemented in conjunction with an at least partially reconfigurable core logic chipset in accordance with the present invention and utilizing interleaved memory and an I/O-based graphics port;

FIG. 5 is a functional block diagram of a portion of a computer system implemented in conjunction with a fully reconfigurable core logic chipset in accordance with the present invention and utilizing non-interleaved memory;

FIG. 6 is a corresponding functional block diagram of a portion of a computer system implemented in conjunction with a fully reconfigurable core logic chipset in accordance with the present invention and utilizing interleaved memory and an I/O-based graphics port; and

FIG. 7 is a flowchart illustrative of a representative configuration process for an at least partially reconfigurable core logic chip set as shown in the preceding figures.

### DESCRIPTION OF A REPRESENTATIVE EMBODIMENT

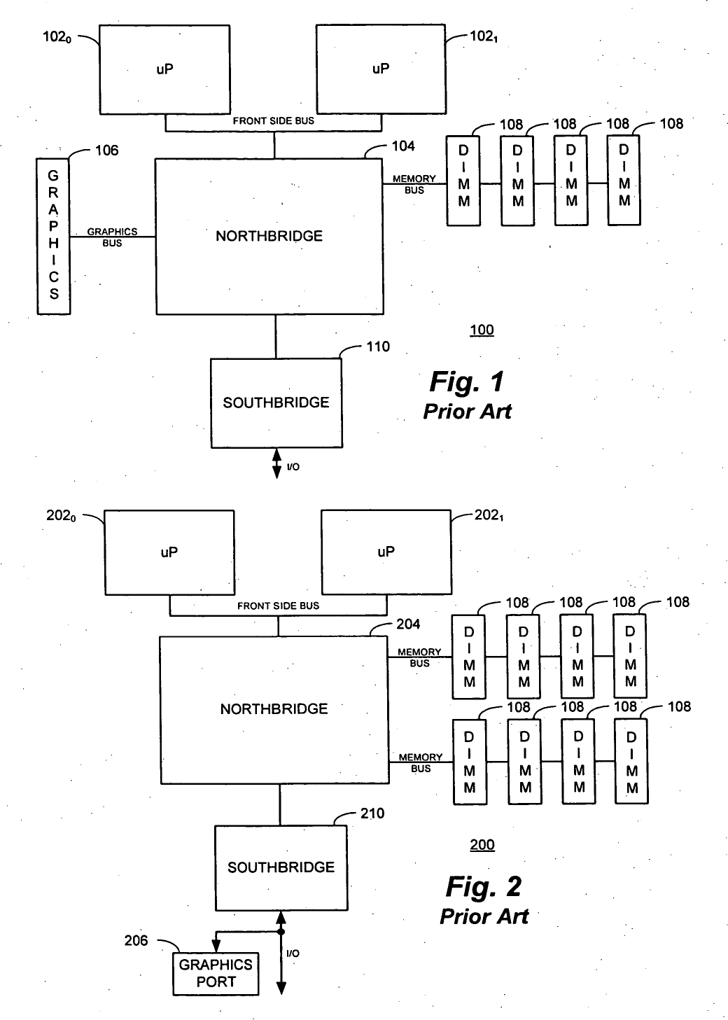

With reference now to FIG. 1, a functional block diagram of a portion of a computer system 100 implemented in conjunction with a conventional core logic chipset and non-interleaved memory is shown. The computer system 100 comprises a pair of microprocessors 102₀ and 102₁ coupled via a front side bus (FSB) to a Northbridge 104 core logic chip. The Northbridge 104, in turn, is coupled to a graphics port 106 by means of a graphics bus and to memory system comprising a number of dual in-line memory modules 108 (DIMMs) through a bi-directional memory bus. A Southbridge 110 chip is coupled to the Northbridge 104 and couples the computer system 100 to an input/output (I/O) bus as illustrated.

With reference additionally now to FIG. 2, a corresponding functional block diagram of a portion of a computer system 200 implemented in conjunction with a conventional core logic chipset with interleaved memory and an I/O-based graphics port is shown. The computer system 200 comprises a pair of microprocessors 202₀ and 202₁ coupled via a front side bus to a Northbridge 204 core logic chip. The Northbridge 204, in turn, is coupled by a pair of bi-directional memory buses to a memory system comprising a number of interleaved DIMMs 108. A Southbridge 210 chip is coupled to the Northbridge 204 and couples the computer system 100 to a graphics port 206 coupled to an input/output (I/O) bus as illustrated.

In the preceding figures, the core logic is represented by the generic names “Northbridge” and “Southbridge”. The Northbridge 104, 204 is the primary core logic chip with the main function of distributing the microprocessor 102, 202 front side bus (FSB) and memory bus bandwidths to the various I/O ports such as the graphics bus. The computer system 100 of FIG. 1 represents a configuration used for, for example, a display intensive application. In this case, pins on the Northbridge 104 are allocated to directly service a graphics bus. On the other hand, the computer system 200 of FIG. 2 represents a configuration that, for example, supports memory intensive applications. In this case a Northbridge 204 is constructed that has two memory busses thus effectively doubling the memory bandwidth of the system.

In both instances, a trade-off has to be made given the finite number of pins on the Northbridge 104, 204 chip as well as the internal logic gates which must be allocated in the latter instance to support two memory busses at the expense of a direct connection for the graphics bus as in the former instance. The graphics function of the computer system 200 of FIG. 2 is not as critical in this particular application set and it can, therefore, be accomplished by moving the graphics connections to the general purpose I/O on the Southbridge 210. The problem with this methodology is that a unique set of core logic chips must be produced for each configuration that one seeks to support.

Currently, there are many specific core logic chipsets on the market. The associated development costs for these chip sets are, of course, very high and will continue to get higher as technology movement to finer lithography is required. These economic forces make it very desirable to find a way to provide for a variety of computer system performance levels without the associated unique, application specific core logic development costs.

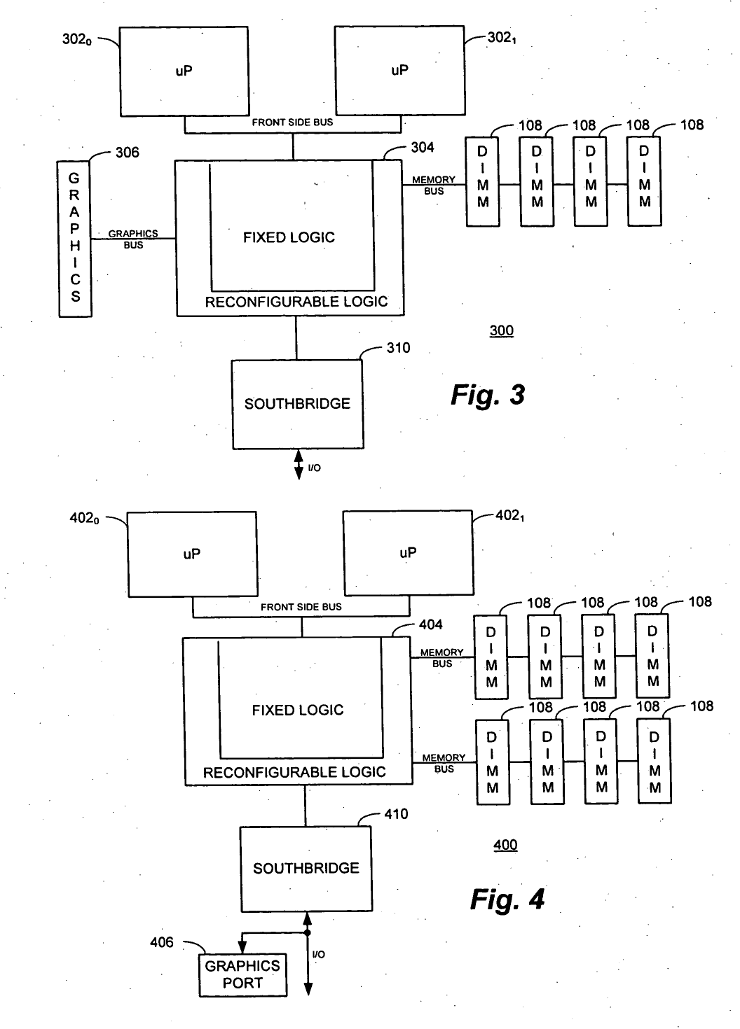

With reference additionally now to FIG. 3, a functional block diagram of a portion of a computer system 300 implemented in conjunction with an at least partially reconfigurable core logic chipset in accordance with the present invention is shown which utilizes non-interleaved memory. The computer system 300 comprises one or more microprocessors, for purposes of illustration only, two microprocessors 302₀ and 302₁ coupled via a front side bus to a reconfigurable core logic chip 304 comprising a portion of fixed logic and another portion of reconfigurable logic. The reconfigurable core logic chip 304, in turn, is coupled to a graphics port 306 by means of a graphics bus and to memory system comprising a number of DIMMs 108 through a bi-directional memory bus. A convention Southbridge 310 chip may be coupled to the reconfigurable core logic chip 304 and couples the computer system 300 to an input/output (I/O) bus as illustrated.

With reference additionally now to FIG. 4, a corresponding functional block diagram of a portion of a computer system 400 implemented in conjunction with an at least partially reconfigurable core logic chipset in accordance with the present invention is shown which utilizes interleaved memory and an I/O-based graphics port. The computer system 400 again comprises one or more microprocessors, for purposes of illustration, microprocessors 402₀ and 402₁, which are coupled via a front side bus to a reconfigurable core logic chip 404. The reconfigurable core logic chip 404, in turn, is coupled by a pair of bi-directional memory buses to a memory system comprising a number of interleaved DIMMs 108. A Southbridge 410 chip is coupled to the reconfigurable core logic chip 404 and couples the computer system 400 to a graphics port 406 coupled to an input/output (I/O) bus as illustrated.

With respect to the computer systems 300 and 400 of the preceding two figures, the reconfigurable logic portion of the reconfigurable core logic chips 304 and 404 respectively, may be conveniently reconfigured to support, for example, connection to a graphics bus and a single memory bus (FIG. 3) or to a pair of interleaved memory buses (FIG. 4) depending on the particular application. In these examples, a portion of the reconfigurable core logic chips 304 and 404 is implemented in fixed logic, for example, to support the front side bus connection to the microprocessors 302 and 402 respectively. It should also be noted that, in addition to the above-described capabilities, at least a portion of the reconfigurable logic of the reconfigurable core logic chips 304 (FIG. 3) and 404 (FIG. 4) may also be utilized to implement one or more direct execution logic (DEL) reconfigurable processor elements such that both the microprocessors 302 (FIG. 3) and 402 (FIG. 4) and the DEL reconfigurable processor elements may function as peers in terms of accessing the computer system 300 (FIG. 3) or computer system 400 (FIG. 4) resources.

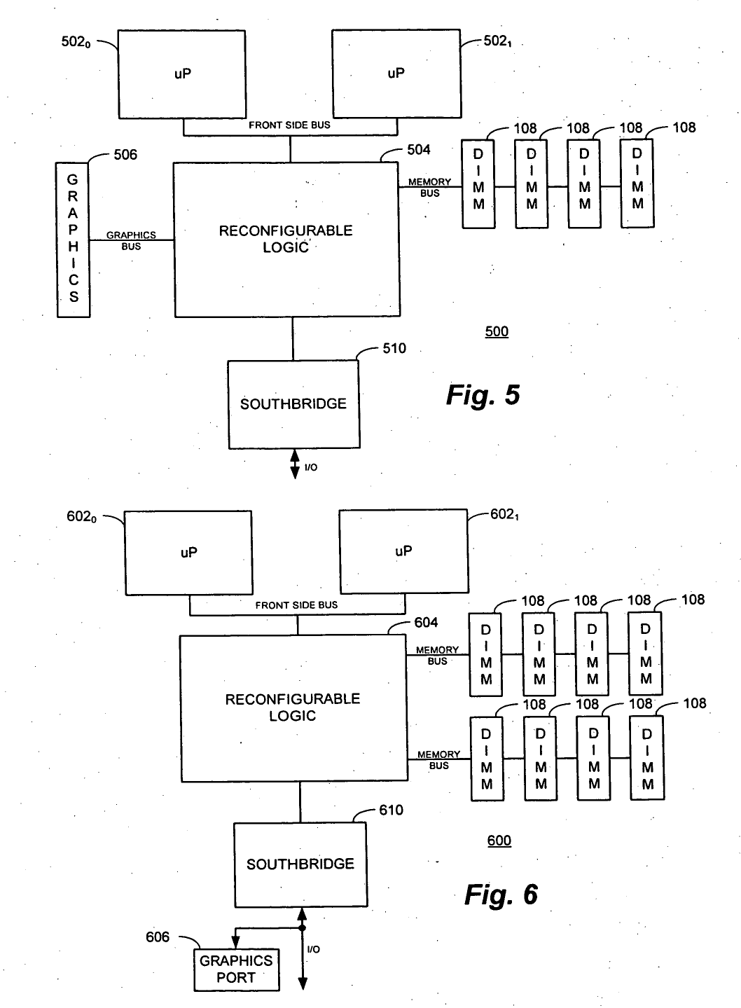

With reference additionally now to FIG. 5, a functional block diagram of a portion of a computer system 500 implemented in conjunction with a fully reconfigurable core logic chipset in accordance with the present invention is shown which utilizes non-interleaved memory. The computer system 500 comprises one or more microprocessors, for purposes of illustration only, two microprocessors 502₀ and 502₁ coupled via a front side bus to a fully reconfigurable core logic chip 504. The reconfigurable core logic chip 504, in turn, is coupled to a graphics port 506 by means of a graphics bus and to memory system comprising a number of DIMMs 108 through a bi-directional memory bus. A convention Southbridge 510 chip may be coupled to the reconfigurable core logic chip 504 and couples the computer system 500 to an input/output (I/O) bus as illustrated.

With reference additionally now to FIG. 6, a corresponding functional block diagram of a portion of a computer system 600 implemented in conjunction with a fully reconfigurable core logic chipset in accordance with the present invention is shown which utilizes interleaved memory and an I/O-based graphics port. The computer system 600 again comprises one or more microprocessors, for purposes of illustration, microprocessors 602₀ and 602₁, which are coupled via a front side bus to a fully reconfigurable core logic chip 604. The reconfigurable core logic chip 604, in turn, is coupled by a pair of bi-directional memory buses to a memory system comprising a number of interleaved DIMMs 108. A Southbridge 610 chip is coupled to the reconfigurable core logic chip 604 and couples the computer system 600 to a graphics port 606 coupled to an input/output (I/O) bus as illustrated.

With respect to the computer systems 500 and 600 of the preceding two figures, the fully reconfigurable core logic chips 504 and 604 respectively, may be conveniently reconfigured to support, for example, connection to a graphics bus and a single memory bus (FIG. 5) or to a pair of interleaved memory buses (FIG. 6) depending on the particular application. In these examples, none of the reconfigurable core logic chips 504 and 604 is implemented in fixed logic and support for the front side bus connection to the microprocessors 502 and 602 respectively is also reconfigurable. Again, it should further be noted that, in addition to the above-described capabilities, at least a portion of the fully reconfigurable core logic chips 504 (FIG. 5) and 604 (FIG. 6) may also be utilized to implement one or more direct execution logic (DEL) reconfigurable processor elements such that both the microprocessors 502 (FIG. 5) and 602 (FIG. 6) and the DEL reconfigurable processor elements may function as peers in terms of accessing the computer system 500 (FIG. 5) or computer system 600 (FIG. 6) resources.

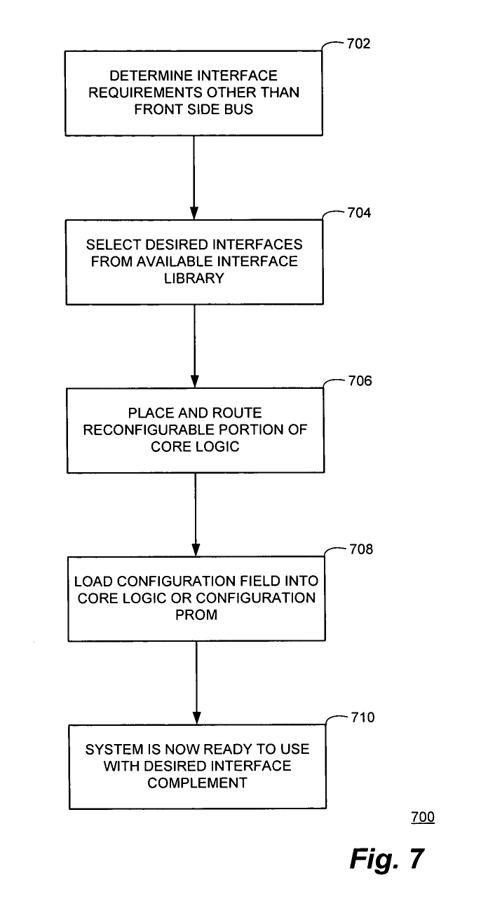

With reference additionally now to FIG. 7, a flowchart illustrative of a representative configuration process 700 for an at least partially reconfigurable core logic chip 304 (FIG. 3) and 404 (FIG. 4) is shown. Reconfigurations of these reconfigurable core logic chips 304, 404 can be effectuated in either a fixed fashion at the time the mother board is assembled or on a dynamic application-by-application basis. At step 702, the user or motherboard manufacturer would decide what mix of interfaces was desired. Conveniently, all of the available interfaces may be reduced to a library of circuit “macros” prior to this step. At step 704, the appropriate macros may be selected from the library.

At step 706, a place and route program may be run to generate the circuitry that would incorporate the desired macro set. The output from this process would be a binary configuration file. At step 708, this file could be loaded either directly into the reconfigurable core logic or into an adjacent configuration programmable read only memory (PROM). The reconfigurable core logic can then be activated causing it to load the configuration file and be ready for use at step 710.

While there have been described above the principles of the present invention in conjunction with specific computer systems architectures, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

What is claimed is:

1. A logic device for coupling at least one microprocessor to a memory system comprising:
a reconfigurable logic section for interfacing said logic device to said memory system.

2. The logic device of claim 1 wherein said reconfigurable logic section is coupled to a memory bus coupled to said memory system.

3. The logic device of claim 1 wherein said reconfigurable logic section further interfaces said logic device to a graphics port.

4. The logic device of claim 1 further comprising:
an additional logic device for coupling said logic device to an input/output bus.

5. The logic device of claim 4 wherein said additional logic device is coupled to said reconfigurable logic section of said logic device.

6. The logic device of claim 4 further comprising:
a graphics port coupled to said input/output bus.

7. The logic device of claim 1 wherein said logic device further comprises:
a fixed logic section for interfacing said logic device to said at least one microprocessor.

8. The logic device of claim 7 wherein said fixed logic section is coupled to a front side bus coupled to said at least one microprocessor.

9. The logic device of claim 1 wherein said at least one microprocessor comprises two or more microprocessors.

10. The logic device of claim 1 wherein said memory system comprises a plurality of memory modules.

11. The logic device of claim 10 wherein said plurality of memory modules comprise DIMM modules.

12. The logic device of claim 1 wherein said reconfigurable logic section implements at least a portion of the core logic functions of a computer system.

13. The logic device of claim 12 wherein said core logic functions are distributed across a series of integrated circuit devices containing reconfigurable logic.

14. The logic device of claim 12 wherein said core logic functions comprise parameterized functions.

15. The logic device of claim 14 wherein said parameterized functions are at least partially selectable during a manufacturing process.

16. The logic device of claim 12 wherein said core logic functions comprise a dynamic reallocation of external bandwidth between two or more ports.

17. The logic device of claim 12 wherein said core logic functions comprise a reallocation of external bandwidth between two or more ports during a manufacturing process.

18. The logic device of claim 7 wherein said reconfigurable logic section and said fixed logic section are co-fabricated on a single integrated circuit die.

19. The logic device of claim 7 wherein said reconfigurable logic section and said fixed logic section are formed by stacking a reconfigurable die element with a fixed logic die element.

20. The logic device of claim 1 wherein said reconfigurable logic section interfaces said logic device to said at least one microprocessor.

21. The logic device of claim 1 wherein said reconfigurable logic section is further configurable as at least one reconfigurable processor.

22. The logic device of claim 21 wherein said at least one reconfigurable processor functions as direct execution logic.

23. The logic device of claim 21 wherein said at least one reconfigurable processor and said at least one microprocessor have substantially similar access to computing system resources.

24. A logic device for coupling at least one microprocessor to a memory system comprising:
a reconfigurable logic section for interfacing said logic device to said memory system; and
a fixed logic section for interfacing said logic device to said at least one microprocessor.

25. The logic device of claim 24 wherein said reconfigurable logic section is coupled to a memory bus coupled to said memory system.

26. The logic device of claim 24 wherein said reconfigurable logic section further interfaces said logic device to a graphics port.

27. The logic device of claim 24 further comprising:
an additional logic device for coupling said logic device to an input/output bus.

28. The logic device of claim 27 wherein said additional logic device is coupled to said reconfigurable logic section of said logic device.

29. The logic device of claim 27 further comprising:
a graphics port coupled to said input/output bus.

30. The logic device of claim 24 wherein said fixed logic section is coupled to a front side bus coupled to said at least one microprocessor.

31. The logic device of claim 24 wherein said at least one microprocessor comprises two or more microprocessors.

32. The logic device of claim 24 wherein said memory system comprises a plurality of memory modules.

33. The logic device of claim 29 wherein said plurality of memory modules comprise DIMM modules.

34. The logic device of claim 24 wherein said reconfigurable logic section implements at least a portion of the core logic functions of a computer system.

35. The logic device of claim 34 wherein said core logic functions are distributed across a series of integrated circuit devices containing reconfigurable logic.

36. The logic device of claim 34 wherein said core logic functions comprise parameterized functions.

37. The logic device of claim 36 wherein said parameterized functions are at least partially selectable during a manufacturing process.

38. The logic device of claim 34 wherein said core logic functions comprise a dynamic reallocation of external bandwidth between two or more ports.

39. The logic device of claim 34 wherein said core logic functions comprise a reallocation of external bandwidth between two or more ports during a manufacturing process.

40. The logic device of claim 24 wherein said reconfigurable logic section and said fixed logic section are co-fabricated on a single integrated circuit die.

41. The logic device of claim 24 wherein said reconfigurable logic section and said fixed logic section are formed by stacking a reconfigurable die element with a fixed logic die element.

42. The logic device of claim 24 wherein said reconfigurable logic section interfaces said logic device to said at least one microprocessor.

43. The logic device of claim 24 wherein said reconfigurable logic section is further configurable as at least one reconfigurable processor.

44. The logic device of claim 43 wherein said at least one reconfigurable processor functions as direct execution logic.

45. The logic device of claim 43 wherein said at least one reconfigurable processor and said at least one microprocessor have substantially similar access to computing system resources.

46. A process for providing a logic device for coupling at least one microprocessor to a memory system comprising:
determining interface requirements for said logic device;
selecting appropriate interfaces from an interface library in response to said determined interface requirements; and
placing and routing a reconfigurable logic section of said logic device in accordance with said selected appropriate interfaces.

47. The process of claim 46 further comprising:
loading a configuration field into core logic in response to said placing and routing of said reconfigurable logic section.

48. The process of claim 46 further comprising:
loading a configuration field into a configuration memory in response to said placing and routing of said reconfigurable logic section.
